(19) United States
(12) Patent Application Publication
(10) Pub. No.: US 2010/0077230 A1
(43) Pub. Date: Mar. 25, 2010

(54) PROTECTING A PROGRAMMABLE MEMORY AGAINST UNAUTHORIZED MODIFICATION

(76) Inventors: Michael Chambers, Erlangen (DE); Paul Renshaw, Cheadle (GB); Michael Kiessling, Freising (DE)

Correspondence Address: HITT GAINES, PC;LSI Corporation, PO BOX 832570, RICHARDSON, TX, 75083, US

(21) Appl. No.: 12/519,156

(22) PCT Filed: Dec. 15, 2006
(86) PCT No.: PCT/EP06/12128

§ 371 Date: Sep. 12, 2009

(51) Int. Cl. G06F 12/14

(52) U.S. Cl. 713/193; 380/277; 711/163; 711/E12.092; 711/103

(57) ABSTRACT

This disclosure provides an apparatus including a programmable memory, a data write path for writing data into the memory and a data read path for reading data from the memory. The memory comprises at least one protected memory field. The data write path comprises a decryption unit that is adapted for receiving encrypted data, decrypting the encrypted data, and writing resulting plain data into the at least one protected memory field. The data read path is adapted for reading out the plain data stored in the protected memory field. The at least one protected memory field is only writable by applying the data to be written into the at least one protected memory field in encrypted form to the data write path.

### CROSS REFERENCE TO RELATED DISCLOSURE

This application is the National Stage of International Application No. PCT/EP2006/012128 entitled “PROTECTING A PROGRAMMABLE MEMORY AGAINST UNAUTHROIZED MODIFICATION,” by Agere Systems Inc., invented by Michael Chambers, et al., having an international filing date of Dec. 15, 2006, and incorporated herein by reference in its entirety.

### TECHNICAL FIELD

The present disclosure relates generally to the field of protecting the integrity of programmed electronic devices. In particular, the present disclosure relates to the field of protecting a programmable memory against unauthorized modification of its contents.

### BACKGROUND

Programmed electronic devices have become ubiquitous. Most of these devices contain a programmable memory like, for example, a Flash memory or an EEPROM memory. It is generally desirable to provide at least some level of assurance of the integrity of the contents of the programmable memory. These contents may comprise program code for execution by the programmed electronic device and/or other information like, for example, identification data, configuration data, and user data.

Any unauthorized modification of the contents of the programmable memory may have undesired or even potentially disastrous consequences. For example, if the programmed electronic device is an automotive control system, any tampering with the software stored in the device may be very dangerous. As another example, if the programmed electronic device provides a media playback function, an unauthorized software modification may circumvent digital rights management settings or other restrictions. As a further example, any possibility to change a serial number or similar identifying information stored in a mobile device—for example, the International Mobile Equipment Identity (IMEI) of a mobile telephone—might be used for fraudulent purposes.

It is known at least in the field of mobile telephones to perform an integrity check at the time of starting up the device. This integrity check may cover program code and/or other critical information. The integrity check comprises calculating a signature of the data to be checked and comparing the calculated signature with a signature that is stored in the device. The signature calculation is performed using a cryptographic method that ensures that it is impossible to alter the data without altering the calculated signature at the same time. A number of suitable methods including, for example, Rivest, Shamir and Adleman (RSA), Digital Signature Algorithm (DSA) and Keyed-Hashing for Message Authentication (HMAC) methods are well known in the art. International patent application No. PCT/EP2006/009690 of Agere Systems Inc., filed on Oct. 6, 2006, describes further details of a startup integrity checking method.

Performing an integrity check only when starting up the device is not effective against unauthorized modifications that occur after the integrity check. This difficulty could be overcome by performing the integrity check periodically during operation of the device. However, such regular integrity checks are difficult to implement in architectures that do not provide a non-maskable interrupt. Furthermore, a periodic integrity check would cause a significant processor load and increase the power consumption of the device. This is especially a problem for mobile devices because such devices have limited processor resources and limited battery capacity. A further problem in connection with all kinds of integrity checks is that the software that implements the integrity check must be trusted and must be stored in an un-modifiable memory like, for example, a ROM.

### SUMMARY

The disclosure provides an embodiment of an integrated semiconductor memory unit including a programmable memory, a data write path for writing data into the memory and a data read path for reading data from the memory, the memory comprising at least one protected memory field, the data write path comprising a decryption unit that is adapted for receiving encrypted data, decrypting the encrypted data, and writing resulting plain data into the at least one protected memory field, the data read path being adapted for reading out the plain data stored in the protected memory field, whereby the at least one protected memory field is only writable by applying the data to be written into the at least one protected memory field in encrypted form to the data write path, further comprising a decryption key storage containing a secret key, wherein the decryption key storage is adapted to be only readable by the decryption unit.

In another aspect, the disclosure provides an embodiment of an electronic device including a programmable memory, a data write path for writing data into the memory and a data read path for reading data from the memory, the memory comprising at least one protected memory field, the data write path comprising a decryption unit that is adapted for receiving encrypted data, decrypting the encrypted data, and writing resulting plain data into the at least one protected memory field, the data read path being adapted for reading out the plain data stored in the protected memory field, whereby the at least one protected memory field is only writable by applying the data to be written into the at least one protected memory field in encrypted form to the data write path, the electronic device comprising a controller unit and a memory unit, the memory unit comprising the programmable memory, wherein the controller unit comprises a CPU, the decryption unit and a decryption key storage containing a secret key, and wherein the decryption key storage is adapted to be only readable by the decryption unit.

In yet another aspect, the disclosure provides a method for providing an update to an integrated semiconductor memory unit or an electronic device. In one embodiment, the method includes creating encrypted data on the basis of plain data to be written into the integrated semiconductor memory unit or the electronic device, and providing the encrypted data to the integrated semiconductor memory unit or the electronic device for decryption and storage within the integrated semiconductor memory unit or the electronic device.

### BRIEF DESCRIPTION OF THE DRAWINGS

Further features, objects and advantages will become apparent when studying the following detailed description, in connection with the annexed drawings, in which:

FIG. 1 is a schematic block diagram of a device comprising a programmable memory and an external data source, according to a first embodiment of the present disclosure,

FIG. 2 is a sequence diagram showing a memory write access and a memory read access in the device of FIG. 1, and

FIG. 3 is a schematic block diagram as in FIG. 1, according to a second embodiment of the disclosure.

### DETAILED DESCRIPTION

The disclosure provides a technique for protecting the integrity of programmed electronic devices and a technique for preventing attacks in which unauthorized data—the data being program code and/or other information—is stored in a programmable memory of a device. The disclosure provides a data write path of a programmable memory with a decryption unit. At least one protected memory field—and in some embodiments the entire programmable memory—may only be programmable via this decryption unit. In other words, in some disclosed embodiments, in order to write data into the protected memory field, the data must be encrypted before it is applied to the data write path. The decryption unit may then decrypt the encrypted data and provide the decrypted data to the protected memory field where the data is stored in decrypted form, i.e., as a plain data. Of course, in some embodiments the encryption must match the decryption performed by the decryption unit if the desired plain data is to be written into the memory field.

The disclosure teaches that a useful modification of the contents of the at least one protected memory field may only be possible if a suitably encrypted version of the plain data to be written into the memory is available. An attacker who does not have the necessary information to prepare this encrypted version cannot modify the memory contents in any meaningful way. It might still be possible for the attacker to write data into the memory, but this data—being the result of the decryption process performed in the data write path—will essentially be random information and can easily be identified. For example, this data will not be executable program code. Only an authorized entity that has access to the secret key and other information used in the decryption process is able to create the required encrypted version of the data.

In the present document, the term “data” comprises all information stored in the programmable memory. For example, such data may be program code for execution by a CPU or other information stored in the programmable memory. In some embodiments, there is no performance penalty for the data read operation because the plain data is stored in the memory and can easily be accessed. The data read path is free of any cryptographic processing elements in these embodiments.

Writing data into the memory entails a decryption and therefore requires some processing time. However, in some embodiments this processing is performed concurrently with the physical memory write operation. Depending on the memory technology used, the speed of the physical memory write operation may actually be the limiting factor in some embodiments. Furthermore, if this disclosure is used to write blocks of consecutive memory cells—like, for example, when performing a software update, some embodiments provide for an efficient decryption by using a block operation mode.

In some embodiments, the decryption—and the corresponding encryption when generating the encrypted data—are performed by a symmetric method with a secret key. This secret key may be stored in a dedicated decryption key storage that is only readable by the decryption unit. It is understood that the entity that creates the encrypted data—like, for example, an external data source—must also have access to the secret key. For example, in some embodiments the secret key may also be stored in an external database.

The electronic device of some embodiments may be a mobile device and/or a communication device and/or an embedded device and/or an authentication device. Examples of an authentication device are a SIM (subscriber identity module) or an RFID tag or device.

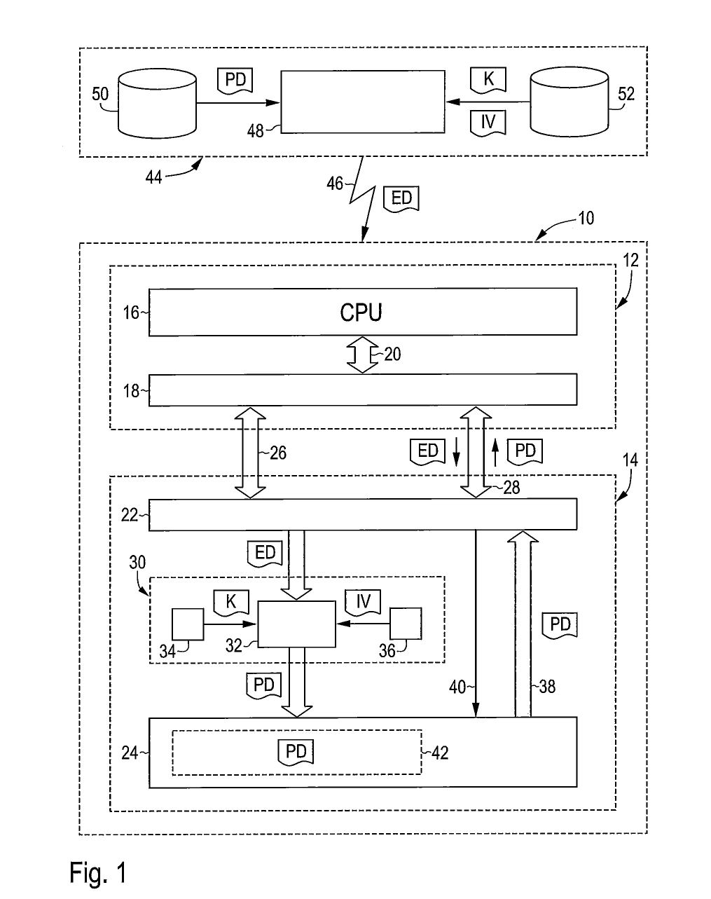

FIG. 1 shows an example of a device 10 comprising a controller unit 12 and a memory unit 14. In the present sample embodiment, the device 10 is a mobile telephone, the controller unit 12 is a baseband integrated circuit, and the memory unit 14 is an integrated Flash memory circuit. However, the present disclosure is not limited to the field of mobile telephones. The disclosure is applicable to all kinds of programmed electronic devices that are to provide some level of protection against execution of unauthorized software and/or against unauthorized modification of data stored therein. Such devices include, without limitation, mobile communication devices, media playback devices, embedded systems, devices for automotive and medical use, external memory devices, authentication devices, and so on. Depending on its type, the device 10 may comprise further components like, for example, a power supply, input and output elements, a high frequency unit, and so on. These further components are not shown in FIG. 1.

The controller unit 12 comprises a CPU (central processing unit) 16 that is connected to a memory interface 18 via an internal memory access path 20. The controller unit 12 generally comprises a number of further integrated components, which are not shown in FIG. 1. For example, these further components may include an integrated memory, a digital signal processor, and so on.

The memory unit 14 of the device 10 comprises an internal memory controller 22 and a programmable memory 24. In the present embodiment, the programmable memory 24 is a Flash memory with a large number of Flash memory cells that are arranged in a plurality of sectors. However, it is apparent that the programmable memory 24 may also be configured in another technology like, for example, as an EEPROM or FRAM. The programmable memory 24 will in many embodiments be a non-volatile memory, but the disclosure is not limited to non-volatile memories.

The controller unit 12 and the memory unit 14 are connected via an address bus 26 and a data bus 28. More particularly, the address and data busses 26, 28 run between the memory interface 18 of the controller unit 12 and the internal memory controller 22 of the memory unit 14. The address and data busses 26, 28 comprise address and data lines as well as control lines for controlling the communication between the controller unit 12 and the memory unit 14. The internal memory controller 22 decodes memory addresses arriving via the address bus 26 and controls all operations within the memory unit 14. These operations will be described below in detail.

The programmable memory 24 is programmed via a data write path 30, which runs from the internal memory controller 22 to the programmable memory 24. The data write path 30 comprises a decryption unit 32, a decryption key storage 34, and an initialization vector storage 36. The decryption unit 32 receives encrypted data ED from the internal memory controller 22, decrypts the data to obtain plain—i.e., decrypted—data PD, and provides the plain data PD to the programmable memory 24 for storage therein.

The decryption key storage 34 and the initialization vector storage 36 hold a decryption key K and an initialization vector IV that are used in the decryption process. In the presently described embodiment, the storages 34, 36 are implemented as one time programmable (OTP) memories that can only be read out by the decryption unit 32. The decryption key K and the initialization vector IV are programmed into these storages 34, 36 at the time of producing the device 10. It is apparent that other memory configurations are possible, as long as the decryption key K and the initialization vector IV cannot be changed by an attacker and cannot be read out, except by the decryption unit 32. For example, the storages 34, 36 may be implemented as a section of the programmable memory 24 or as a section of RAM memory that is initialized at the time of starting up the device 10 under control of a ROM based startup routine. In such embodiments, suitable precautions must be taken to ensure that only the ROM based startup routine can write into the storages 34, 36.

The decryption unit 32 performs the decryption process according to any one of a number of cryptographic methods that are, as such, known in the art. In many embodiments, a symmetric block cipher method is used, but the disclosure is not limited to symmetric methods or to block cipher methods. Examples of suitable methods are the well known AES, IDEA, DES and 3DES methods. These methods are preferably used in a block operation mode like, for example, one of the ECB and CBC block operation modes for DES. It is understood that, for a symmetric method, there is no difference between the encryption and decryption steps. The term “decryption” will nevertheless be used in the present document in order to clarify that the decryption unit 32 takes the encrypted data ED and outputs the plain data PD to the programmable memory 24.

In many embodiments of the present disclosure the encrypted data ED is decrypted during or in connection with the process of writing the resulting plain data PD into the programmable memory 24. Writing data into a Flash memory or another non-volatile memory is rather slow because of physical constraints. Therefore, if the decryption and the writing operation are performed concurrently, the decryption will in many embodiments not require any additional time, other than the time that is needed in any case for the operation of writing the data into the memory. While in many embodiments the timing of the decryption operation is not critical, there are also embodiments in which a suitable buffer—e.g., a FIFO queue—is provided within the internal memory controller 22 and/or the data write path 30 in order to decouple any timing constraints.

In many embodiments, the disclosure will be used for updating software stored in the programmable memory 24. This involves a sequential writing operation into consecutive memory cells of the programmable memory 24. The corresponding decryption in the decryption unit 32 incurs little overhead, especially if one of the above-mentioned block modes of operation is used.

Data is read out from the programmable memory 24 via a data read path 38, which connects the programmable memory 24 to the internal memory controller 22. In the present embodiment, the data read path 38 does not contain any cryptographic elements and therefore outputs any data—for example, the plain data PD—as it is stored in the programmable memory 24. Because there are no complex data manipulation steps, the timing of the read operation is only determined by the programmable memory 24. In other words, the present embodiment achieves the desired protection against manipulation without any performance penalty for memory read operations. This is true both for sequential and for random access read operations.

The internal memory controller 22 is further adapted to erase parts of the programmable memory 24 by applying suitable signals to an erase signal line 40. The erase function is used for preparing a data write operation in a way that is customary for Flash memories.

FIG. 1 shows a protected memory field 42 of the programmable memory 24 into which the plain data PD is written. In some embodiments, only parts of the programmable memory 24 are protected against unauthorized modification while other parts—outside the protected memory field 42—are writable without any protection. For example, write operations to memory cells outside the protected memory field 42 may bypass the decryption unit 32 within the data write path 30 or may use an additional, direct write path (not shown). However, in other embodiments, there are no unprotected memory portions such that the protected memory field 42 covers the entire programmable memory 24.

Some embodiments may have more than one protected memory field 42 within the programmable memory 24. The size and arrangement of the one or more protected memory fields 42 may be fixed or settable. For example, in some embodiments the memory unit 14 may contain a register (not shown) that determines the regions—e.g., sectors or groups of sectors—of the programmable memory 24 that are to be included into or excluded from the one or more protected memory fields 42. This register may, for example, be formed as a one time programmable (OTP) memory, and it may be programmed at the time of producing the device 10.

The possibility of excluding certain regions of the programmable memory 24 from the protection scheme of the present disclosure is useful or necessary in embodiments in which, for example, the memory unit 14 contains some kind of Flash file system (FFS) for storing persistent data. In such embodiments, it must be possible for the controller unit 12 and/or the internal memory controller 22 to write administrative data of the file system into the programmable memory 24. However, since the controller unit 12 and/or the internal memory controller 22 in many embodiments cannot access the key K and therefore cannot encrypt the administrative data, there must be a non-protected portion of the programmable memory 24 into which the administrative data can freely be written.

All in all, the one or more protected memory fields 42 of the programmable memory 24 can only be modified in a meaningful way if an encrypted version of the data to be written into the programmable memory 24 is available. Creating this encrypted version requires knowledge of the cryptographic method, the key K and the initialization vector IV. Since a symmetric cipher is used in the presently described embodiment, the same key K and initialization vector IV are used both for the encryption and for the subsequent decryption. In other words, the key K and the initialization vector IV that are contained in the storages 34, 36 must also be available when generating the encrypted data ED.

There may be embodiments in which the controller unit 12 or another component of the device 10 has access to the key K and the initialization vector IV. In such embodiments, it would be possible to generate suitably encrypted data ED within the device 10. However, such embodiments may offer less than the optimum security if the device 10 is tampered with or if fraudulent software is executed by the device 10. Consequently, in many other embodiments there are no provisions within the device 10 to encrypt data to be written into the programmable memory 24. In such embodiments, the device 10 must receive the encrypted data ED from an external data source 44 like, for example, an external service provider or a mobile network operator or an authorized service center.

FIG. 1 shows an example of the external data source 44 that sends the encrypted data ED to the device 10 via a communication path 46. The communication path 46 may be a wireless communication channel or a wire-bound data transmission link. The external data source 44 comprises an encryption unit 48 implementing a cryptographic method that corresponds to that of the decryption unit 32. The encryption unit 48 receives the plain data PD to be encrypted from a file system 50, and it receives the key K and the initialization vector IV from a database 52.

For example, the database 52 may contain an individual record for each device 10 that has ever been manufactured, each record containing the key K and the initialization vector IV of the device 10, as well as other administrative information. The serial number of the device 10 or other suitable identification data may serve as an index for accessing this information. In other embodiments, the database 52 may contain fewer records like, for example, only one record for each manufacturing batch or even only one record for each type of the device 10. Having a variety of keys K ensures that software updates are properly matched to the various devices 10 and also increases the overall security of the protection scheme in case one of the keys K is compromised. However, the disclosure also includes embodiments in which only a single key K and/or a single initialization vector IV are used. In such embodiments, no database 52 is necessary.

The key K must be kept secret in order to ensure that an unauthorized attacker cannot create a properly encrypted version of some unauthorized data for storage in the protected memory field 42. The presently described embodiment is especially well protected in this respect because the key K is neither part of nor accessible to any software of the device 10 that could be monitored or analyzed by an attacker. In particular, the decryption key storage 34 is only connected to the decryption unit 32 and cannot be read out by the controller unit 12 or any other entity of the device 10.

In order to maintain the secrecy of the key K, the cipher method used by the decryption unit 32 should have the property that no useful information about the key K can be obtained even if a number of decryption processes are observed, i.e., pairs of encrypted data ED and corresponding plain data DP are known. The cipher methods mentioned above and other known cipher methods are suitable in this respect.

In some embodiments, the decryption unit 32 uses a derived key DK instead of the key K that is contained in the decryption key storage 34. The derived key DK may be obtained from the stored key K by any method, and further information may be incorporated into the derived key DK in this process. For example, the derived key DK may be obtained by applying a cryptographic hash function CH to both the stored key K and an address ADR of the memory write operation as follows:

DK=CH(K, ADR)

It is understood that the same derived key DK must also be used when preparing the encrypted data ED.

Using a derived key DK like, for example, the one specified above further increases the security of the method against manipulation because a different key will be used for memory write operations to each address. Even if an attacker manages to spy out one derived key DK, it will be useless for subsequent write operations to different memory addresses.

In some embodiments, not only the key K, but also the initialization vector IV is kept secret. However, this is not strictly necessary from a cryptographic point of view, and consequently there are also embodiments in which the initialization vector IV is not a secret value. For example, in some embodiments a unique serial number of the device 10 is used as the initialization vector IV.

Generally, there are a number of possible ways for individualizing the initialization vector IV, and any of these ways may be used in various embodiments. For example, the initialization vector IV may be specific to the individual devices 10—as in the example given in the previous paragraph—, or it may be specific to the individual users, or it may be specific to the individual write operations. In some embodiments, the initialization vector IV may depend on or be identical to an address of the memory write operation like, for example, the start sector address.

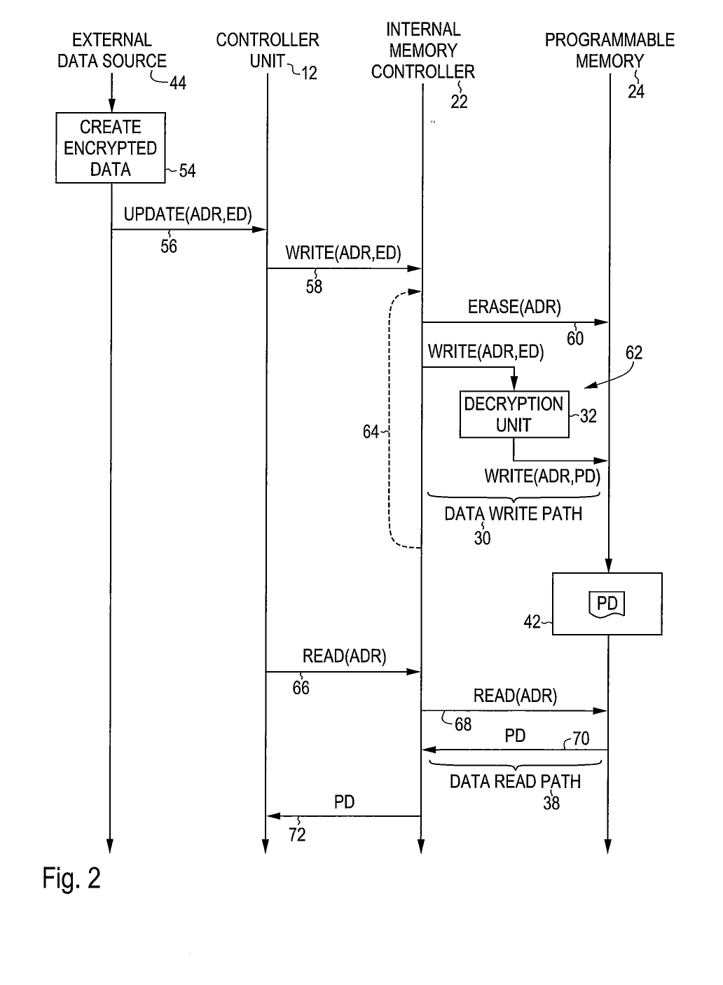

FIG. 2 shows an exemplary flow sequence comprising the steps of writing data into the programmable memory 24 and reading data from the programmable memory 24.

When the data—for example, application software—stored in the programmable memory 24 is to be updated, the external data source 44 executes a step 54 of creating the encrypted data ED, using the new plain data PD and suitable values for the decryption key K and initialization vector IV, as described above.

In step 56, the encrypted data ED is transferred to the device 10—more particularly, to its controller unit 12—via the communication path 46. FIG. 2 shows an example of a command UPDATE(ADR,ED) that instructs the device 10 to perform an update operation and includes the update start address ADR and the encrypted data ED. In step 58, the controller unit 12 forwards this information in a write command WRITE(ADR,ED) to the memory unit 14—more particularly, to the internal memory controller 22.

In response to receiving the write command WRITE(ADR,ED), the internal memory controller 22 executes the steps necessary for programming the programmable memory 24. First, one or more sectors of the programmable memory 24 are erased in step 60. Then, in step 62, the encrypted data ED to be programmed is passed through the decryption unit 32 in the data write path 30 such that the actual plain data PD is written into the protected memory field 42. Steps 60 and 62 may be repeated as often as necessary if there is further data to be written into the programmable memory 24; this possibility is shown in FIG. 2 by dashed arrow 64.

After completion of the update process, the protected memory field 42 contains the plain data PD. This data can now be read out in the usual way. For example, a memory read command READ(ADR) may be issued by the controller unit 12 in step 66. The internal memory controller 22 performs a corresponding memory read operation in step 68. In step 70, the programmable memory 24 outputs the plain data PD via the data read path 38 to the internal memory controller 22. Finally, the internal memory controller 22 forwards the plain data PD to the controller unit 12 in step 72. For example, the plain data PD may be application program code that is executed by the CPU 16 of the controller unit 12.

In the embodiment of FIG. 1, all elements of the memory unit 14 are integrated into a single semiconductor chip or a single semiconductor package. In particular, the decryption unit 32, the programmable memory 24 and the lines by which the plain data PD is programmed into the memory 24 are all contained in this semiconductor chip or package. This configuration provides particularly good protection against physical attacks that attempt to circumvent the decryption unit 32 by connecting data write lines directly to the programmable memory 24.

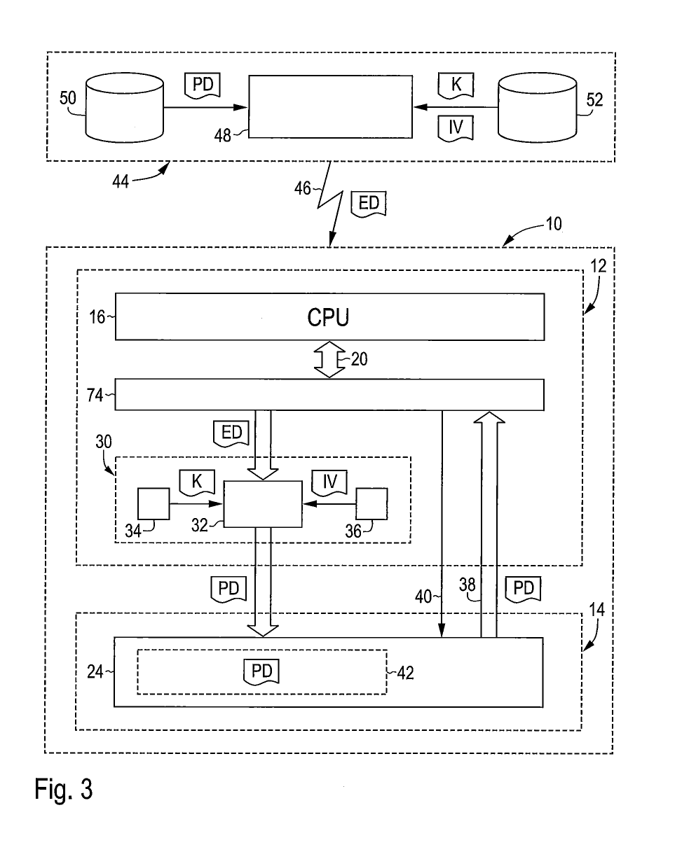

FIG. 3 shows an alternative embodiment in which the decryption unit 32 and the associated elements of the data write path 30 are integrated in the controller unit 12. Furthermore, the memory interface 18 and the internal memory controller 22 of the embodiment of FIG. 1 are integrated into a combined memory controller 74 in the embodiment of FIG. 3. An advantage of the embodiment of FIG. 3 is that the memory unit 14 may be a standard memory device like, for example, a Flash memory chip. Furthermore, the controller unit 12 may be designed such that the CPU 16 and the decryption unit 32 share common elements like, for example, arithmetic or logic processing units. In the embodiment of FIG. 3, care should be taken that an attacker cannot physically connect data write lines directly to the memory unit 14.

All in all, protection is provided for the data stored in the protected memory field 42 of the programmable memory 24 against unauthorized manipulation. If the protected data comprises software that is to be executed on the device 10, then this software can be considered as trusted without any integrity check. It is understood that suitable precautions should be taken against possible attacks that involve physically removing—e.g., unsoldering—or replacing the memory unit 14.

This disclosure provides an apparatus including a programmable memory, a data write path for writing data into the memory and a data read path for reading data from the memory. The memory comprises at least one protected memory field. The data write path comprises a decryption unit that is adapted for receiving encrypted data, decrypting the encrypted data, and writing resulting plain data into the at least one protected memory field. The data read path is adapted for reading out the plain data stored in the protected memory field. The at least one protected memory field is only writable by applying the data to be written into the at least one protected memory field in encrypted form to the data write path.

The disclosure further provides an electronic device, an external data source, a method for accessing the programmable memory, and a method for providing an update to an electronic device. A technique is also provided for protecting the integrity of the electronic device by preventing attacks in which unauthorized data—the data being program code and/or other information—is stored in the programmable memory.

The particulars contained in the above description of sample embodiments should not be construed as limitations of the scope of the disclosure, but rather as exemplifications of some embodiments thereof. Accordingly, the scope of the disclosure should be determined not by the embodiments illustrated, but by the appended claims and their legal equivalents.

What is claimed is:

1. An integrated semiconductor memory unit comprising:
a programmable memory, the memory comprising at least one protected memory field;
a data write path for writing data into the memory, the data write path comprising a decryption unit that is adapted for receiving encrypted data, decrypting the encrypted data, and writing resulting plain data into the at least one protected memory field;
a data read path for reading data from the memory, the data read path being adapted for reading out the plain data stored in the protected memory field, whereby the at least one protected memory field is only writable by applying the data to be written into the at least one protected memory field in encrypted form to the data write path; and
a decryption key storage containing a secret key, wherein the decryption key storage is adapted to be only readable by the decryption unit.

2. The integrated semiconductor memory unit of claim 1, wherein the data read path is free of any cryptographic processing elements.

3. The integrated semiconductor memory unit of claim 1, wherein the decryption unit is adapted for using, in the decryption process, one of the secret key and a derived key that incorporates information from the secret key.

4. The integrated semiconductor memory unit of claim 1, wherein the decryption unit is adapted for using a symmetric block cipher method for obtaining the plain data from the encrypted data.

5. The integrated semiconductor memory unit of claim 4, wherein the decryption unit is adapted for using an individualized initialization vector in the decryption process.

6. The integrated semiconductor memory unit of claim 1, wherein the programmable memory is a Flash memory.

7. The integrated semiconductor memory unit of claim 1, wherein the at least one protected memory field is a single protected memory field that takes up the entire programmable memory.

8. The integrated semiconductor memory unit of claim 1, further comprising an internal memory controller.

9. An electronic device comprising:
a programmable memory, the memory comprising at least one protected memory field;
a data write path for writing data into the memory, the data write path comprising a decryption unit that is adapted for receiving encrypted data, decrypting the encrypted data, and writing resulting plain data into the at least one protected memory field;
a data read path for reading data from the memory, the data read path being adapted for reading out the plain data stored in the protected memory field, whereby the at least one protected memory field is only writable by applying the data to be written into the at least one protected memory field in encrypted form to the data write path;
a controller unit, wherein the controller unit comprises a CPU, the decryption unit and a decryption key storage containing a secret key;
a memory unit, the memory unit comprising the programmable memory; and
wherein the decryption key storage is adapted to be only readable by the decryption unit.

10. The electronic device of claim 9, wherein the at least one protected memory field of the memory unit comprises program code for execution by the CPU.

11. The electronic device of claim 9, wherein the device is one of a mobile communication device, a media playback device, an embedded system, a device for automotive use, an authentication device, and a device for medical use.

12. The electronic device of claim 9, wherein the data read path is free of any cryptographic processing elements.

13. The electronic device of claim 9, wherein the decryption unit is adapted for using, in the decryption process, one of the secret key and a derived key that incorporates information from the secret key.

14. The electronic device of claim 9, wherein the decryption unit is adapted for using a symmetric block cipher method for obtaining the plain data from the encrypted data.

15. The electronic device of claim 14, wherein the decryption unit is adapted for using an individualized initialization vector in the decryption process.

16. The electronic device of claim 9, wherein the programmable memory is a Flash memory.

17. The electronic device of claim 9, wherein the at least one protected memory field is a single protected memory field that takes up the entire programmable memory.

18. A method for providing an update to an integrated semiconductor memory unit,
wherein the integrated semiconductor memory unit comprises a programmable memory, a data write path for writing data into the memory and a data read path for reading data from the memory,
the memory comprising at least one protected memory field,
the data write path comprising a decryption unit that is adapted for receiving encrypted data, decrypting the encrypted data, and writing resulting plain data into the at least one protected memory field,
the data read path being adapted for reading out the plain data stored in the protected memory field,
whereby the at least one protected memory field is only writable by applying the data to be written into the at least one protected memory field in encrypted form to the data write path,
further comprising a decryption key storage containing a secret key, wherein the decryption key storage is adapted to be only readable by the decryption unit,
the method comprising:
creating encrypted data on the basis of plain data to be written into the integrated semiconductor memory unit, and
providing the encrypted data to the integrated semiconductor memory unit for decryption and storage within the integrated semiconductor memory unit.

19. A method for providing an update to an electronic device,
wherein the electronic device comprises a programmable memory, a data write path for writing data into the memory and a data read path for reading data from the memory,
the memory comprising at least one protected memory field,
the data write path comprising a decryption unit that is adapted for receiving encrypted data, decrypting the encrypted data, and writing resulting plain data into the at least one protected memory field,
the data read path being adapted for reading out the plain data stored in the protected memory field,
whereby the at least one protected memory field is only writable by applying the data to be written into the at least one protected memory field in encrypted form to the data write path,
the electronic device comprising a controller unit and a memory unit, the memory unit comprising the programmable memory,
wherein the controller unit comprises a CPU, the decryption unit and a decryption key storage containing a secret key, and
wherein the decryption key storage is adapted to be only readable by the decryption unit,
the method comprising:
creating encrypted data on the basis of plain data to be written into the electronic device, and
providing the encrypted data to the electronic device for decryption and storage within the electronic device.

20. The method as recited in claim 19 wherein the electronic device is a mobile communication device.
